(19) United States
(12) Patent Application Publication
(10) Pub. No.: US 2006/0185487 A1
(43) Pub. Date: Aug. 24, 2006

(54) Automatic card cutter

(76) Inventors: Chou Cheng Li, Taipei Hsien (TW); Ming Nan Huang, Taipei Hsien (TW)

Correspondence Address: Chou Cheng Li, 235 Chung - Ho, Box 8-24, Taipei, TW

(21) Appl. No.: 11/062,284

(22) Filed: Feb. 22, 2005

(51) Int. Cl. B23D 19/04

(52) U.S. Cl. 83/498; 83/425.4

(57) ABSTRACT

An automatic card cutter capable of continuously cutting paper material of various amounts and sizes comprises a feeding unit, a transport unit, a transverse cutting unit, a longitudinal cutting unit, a waste material collector, a card collector and a shell body. The feeding unit has two spacing-adjustable side plates. Each of the side plates is provided with a flexible plate, an impression wheel against the flexible plate and drive set for driving the impression wheel, whereby paper materials of various amounts can be fed into the cutter smoothly. The longitudinal cutting unit comprises a plurality of slidable wheel knife sets, so that the cutting width of the paper material can be easily set.

### FIELD OF THE INVENTION

The present invention relates to automatic card cutters, and more particularly to an automatic card cutter that can cut a variety of papers quickly and accurately into cards of selected sizes.

### BACKGROUND OF THE INVENTION

An automatic card cutter of the prior art comprises a shell body 1 composed of a plurality of plates having a front opening, wherein carious units are retained. The shell body 1 further includes an upper cover 11, a feeding unit 2 sucking the paper material to be cut into the automatic card cutter, a transport unit 3 delivering the paper material in the cutter, a transverse cutting unit 4 cutting the paper material off in a transverse direction, a longitudinal cutting unit 5 cutting the paper material off in a longitudinal direction, and a card collector 7 collecting cards cut from the paper material.

A stack of paper sheets is guided into the feeding unit 2 and then transported by the transport unit 3 through the transverse cutting unit 4 for the first cut and the longitudinal cutting unit 5 for the secondary cut. The cards cut off from the paper sheets are collected and stacked in the card collector 7, and the leftovers from the paper material are dumped and collected in the waste material collector 6.

However, the automatic card cutter of the prior art is not suitable for feeding too many paper sheets at a time, because the spacing between a driver set 24 of the feeding unit 2 and a movable lateral plate 23 is fixed, and therefore the thickness of the stack of paper sheets is limited. Further, it is another concern that the friction between the paper sheets and the driver set 24 would be lessened, resulting in an interruption of material feeding.

Further, limited by the width of the automatic card cutter, only paper sheets of smaller sizes can be accepted. Therefore, the upper and the lower wheel knives 54, 57 are fewer and fixed, leaving no room for transverse displacement. If the width of the cards to be cut off from the material changes, the longitudinal cutting unit 5 has to be removed from the cutter for replacement, which is time consuming.

### SUMMARY OF THE INVENTION

Accordingly, the primary objective of the present invention is to provide an automatic card cutter capable of cutting a variety of papers quickly and accurately into cards of selected sizes.

To achieve the above objective, the automatic card cutter comprises a feeding unit, a transport unit, a transverse cutting unit, a longitudinal cutting unit, a waste material collector, card collector, and a shell body that retains and covers those units. The present invention is characterized by a feeding unit having two side plates each having a driver set equipped with an impression wheel, a transmission shaft mounted between the side plates and going though each of the impression wheels, a motor set driving each of the driver sets through the transmission shaft, and a pair of flexible plates respectively pivotally mounted on the front sides of the side plates and urged by springs installed thereon; the other ends of the flexible plates are respectively pressed against the impression wheels. The automatic card cutter further includes an adjustment frame straddled between and connected to two side plates for adjusting the locations of the side plates.

Furthermore, an upper side of each of said side plates is further provided with a series of descending grooves for the engagement of a retaining block. Each of said retaining blocks is connected to a link rod through a spring. Each of said link rods has a secondary end secured at said pivot of corresponding said flexible plate.

A central section of said transmission shaft is further provided with a secondary impression wheel, and wherein a secondary flexible plate is installed between said flexible plates of said side plates and pivotally mounted on a skewed plate in an entry opening of said shell body. The pivotally mounted end of said secondary flexible plate being urged by a spring installed on said skewed plate; a free end of said secondary flexible plate leaning against said secondary impression wheel.

The adjustment frame further comprises a pair of parallel slide rods, a pair of pull blocks slidably mounted across said slide rods, a two-way screw bolt extended parallel to said slide rods and going through said pull blocks. At least one adjustment knob installed on one end of said two-way screw bolt, and two fixed blocks respectively connecting two ends of said slide rods and said two-way screw bolt.

The longitudinal cutting unit further comprises two fixed side plates, two parallel slide rods connecting said side plates, an upper wheel shaft provided with an upper gear wheel at one end mounted between said side plates, a lower wheel shaft provided with a lower gear wheel at said end of said upper gear wheel mounted between said side plates, a plurality of upper wheel knives mounted along said upper wheel shaft, a corresponding set of wheel knife mounts for retaining said upper wheel knives each having a guide member, a plurality of lower wheel knives mounted along said lower wheel shaft, and an upper cover.

The various objects and advantages of the present invention will be more readily understood from the following detailed description when read in conjunction with the appended drawings.

### BRIEF DESCRIPTION OF THE DRAWINGS

FIG. 1 is a perspective view of an automatic card cutter according to the present invention.

FIG. 2 is a perspective view of the automatic card cutter in FIG. 1 viewed from another perspective angle.

FIG .3 is an exploded perspective view of the feeding unit of the automatic card cutter in Fig.l.

FIG. 4 is a perspective view of the feeding unit of the automatic card cutter in FIG. l.

FIG. 5 is an exploded perspective view of the longitudinal cutting unit of the automatic card cutter in FIG. 1.

FIG. 6 is a perspective view of the longitudinal cutting unit of the automatic card cutter in FIG. 1.

### DETAILED DESCRIPTION OF THE PREFERRED EMBODIMENTS

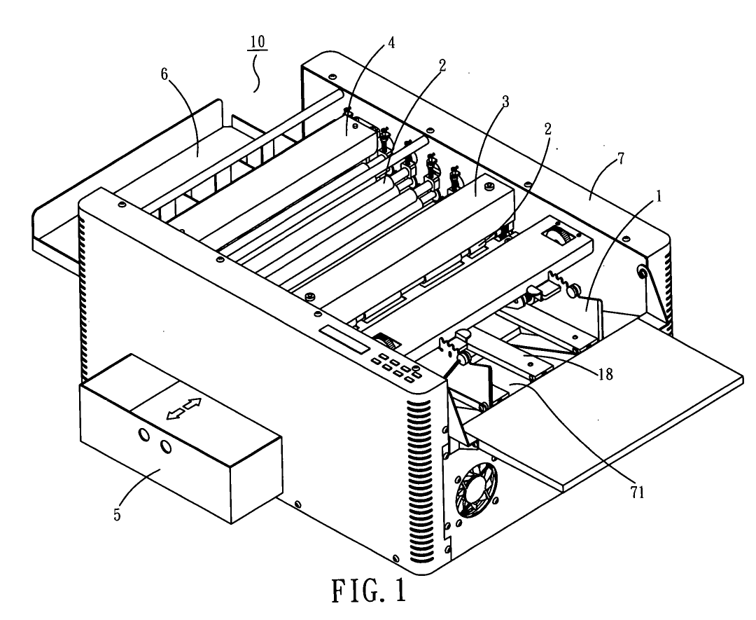

Referring to FIG. 1, an automatic card cutter 10 according to the present invention comprises a feeding unit 1, a transport unit 2, a transverse cutting unit 3, a longitudinal cutting unit 4, a waste material collector 5, card collector 6, and a shell body 7 that retains and covers those units. A material to be cut (not shown) is guided into the feeding unit 1, being carried by the transport unit 2 to the transverse cutting unit 3 and the longitudinal cutting unit 4 for cutting in the transverse and longitudinal directions. The products are then collected by the card collector 6, whereas the waste material produced in the cutting will fall into the waste material collector 5.

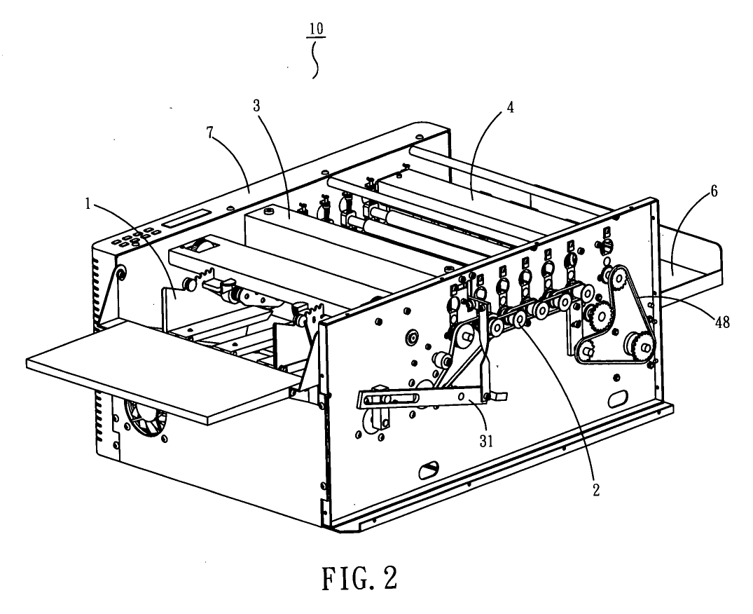

Except for the feeding unit 1 and the longitudinal cutting unit 4, the units of the automatic card cutter are similar to those of the conventional automatic card cutters. For example, the transport unit 2, as shown in FIG. 2, is simply an elongated version of a transport unit of the prior art. The reciprocating member 31, as shown in FIG. 2, of the transverse cutting unit 3 is the same as that in a conventional automatic card cutter. Further, the sensors disposed within the automatic card cutter for safety are also of the prior art. Since the above mentioned units similar to those of the prior art are not in the scope of the present invention, their working principles will not be described in this specification.

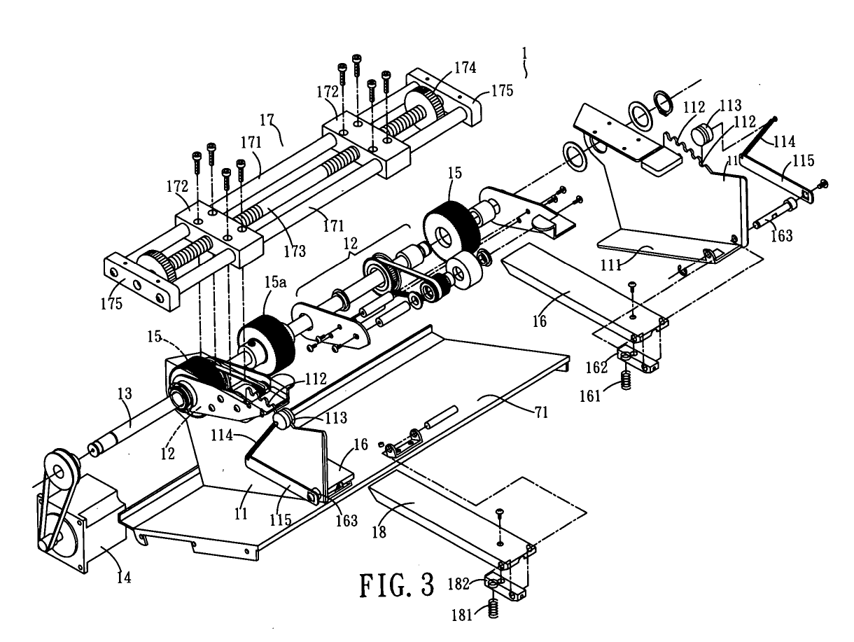

FIG. 3 is an exploded view of the feeding unit 1 of the automatic card cutter 10 of the present invention, wherein the feeding unit 1 comprises two side plates 11, two driver sets 12 each having a impression wheel 15 disposed between the side plates 11, a transmission shaft 13 going through the impression wheels 15 of the driver sets 12, and a motor set 14 for driving the driver sets 12 through the transmission shaft 13. Each of the side plates 11 has a skewed bottom member 111 extended from a bottom side of the inner wall of a side plate 11. The feeding unit 1 further includes a pair of flexible plates 16 each mounted on one end of the inner bottom side of a corresponding side plate 11 and an adjustment frame 17 mounted between the top sides of the side plates 11 coupled with the side plates 11. The flexible plates 16 are respectively urged by springs 161 located at front bottom ends of the side plates 11, so that the flexible plates 16 can lean on the impression wheels 15. FIG. 4 shows the assembly of the various parts of the feeding unit 1. The springs 161 are confined between a corresponding spring base 162 and a corresponding skewed bottom member 111. On the upper side of each of the side plates 11, there exists a series of descending grooves 112 for the engagement of a retaining block 113. The retaining blocks 113 are respectively connected to link rods 115 through respective springs 114. The other end of each of the link rods 115 is secured to a rotational axis 163 of a flexible plate 16. Thereby, the flexible plates 16 are urged by the spring force due to the confinement of the springs 161 by the skewed bottom members 111 and the spring force due to the link rods 115 by the springs 114, so as to produce a pinch force against the impression wheels 15. As shown in FIG. 4, since there still exists a room for further impression between the engaging ends of the flexible plates 16 and the impression wheels 15 and the skewed bottom members 111 of the side plates 11 (indicated by the up and down arrows), a large amount of paper sheets can be confined between the flexible plates 16 and the impression wheels 15, whereby a substantial friction will be maintained between the impression wheels 15 and the paper sheets and whereby paper sheets can be continuously fed into the automatic card cutter 10 for cutting.

Moreover, the force on the link rods 115 from the spring 114 can be adjusted by moving the retaining blocks 113 from a lower pair of the grooves 112 on the top sides of the side plates 11 to a higher pair, thereby enhancing the pinch force between the flexible plates 16 and the impression wheels 15. To reduce the pinch force, move the transmission shaft 13 from a higher pair of the grooves 112 on the top sides of the side plates 11 to a lower pair. Therefore, the pinch force between the flexible plates 16 and the impression wheels 15 can be changed according to either the degree of fatigue in flexibility of the springs 114, 161 or the surface roughness of the paper material.

Referring to FIGS. 3 and 4, the center of the transmission shaft 13 is further provided with a secondary impression wheel 15a, and a secondary flexible plate 18 is installed between the flexible plates 16 of the side plates 11. The bottom end of the secondary flexible plate 18 is pivotally mounted on a skewed plate 71 in the entry opening of the shell body 7, as shown in FIG. 1. The secondary flexible plate 18 is further a spring base 182 and a spring 182 confined between the spring base 182 and the skewed plate 71. The other end of the secondary flexible plate 18 leans against the secondary impression wheel 15a of the transmission shaft 13. Thereby, when the size of the fed paper sheets is large, the secondary flexible plate 18 and the secondary impression wheel 15a assist supporting the weight of the paper sheets and prevent a central downward curvature of the paper sheets due to gravity, which would affect the accuracy of the cutting and even the feeding of material.

Further, the adjustment frame 17 comprises a pair of parallel slide rods 171, a pair of pull blocks 172 slidably mounted across the slide rods 171, a two-way screw bolt 173 extended parallel to the slide rods 171 and going through the pull blocks 172, and two fixed blocks 175 respectively connecting two ends of the slide rods 171 and the two-way screw bolt 173. The two-way screw bolt 173 has two screw threads formed at its opposite ends running in opposite senses and includes two adjustment knobs 174 respectively mounted on those two sections having a screw thread, whereby the pull blocks 172 will move along the two-way screw bolt 173 simultaneously in either inward or outward directions. Accordingly, the side plates 11 linked to the adjustment frame 17 will move in either inward or outward directions. Therefore, a user can adjust the spacing between the side plates 11 to accommodate paper materials of different widths.

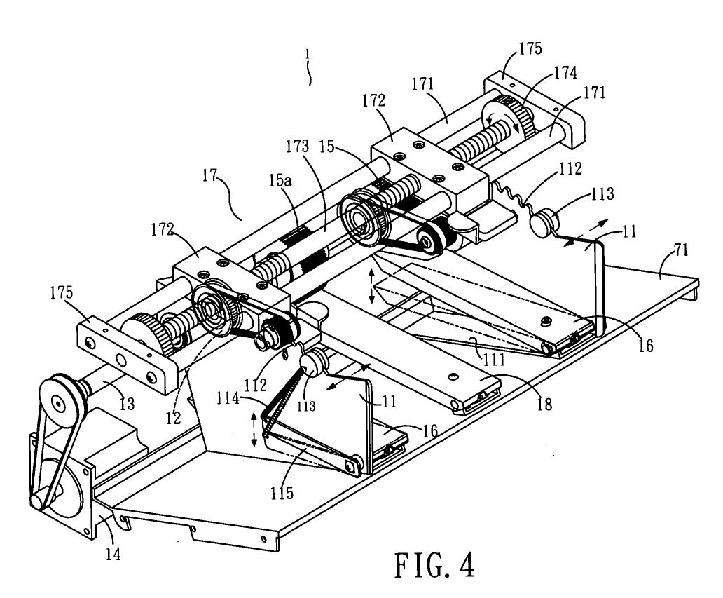

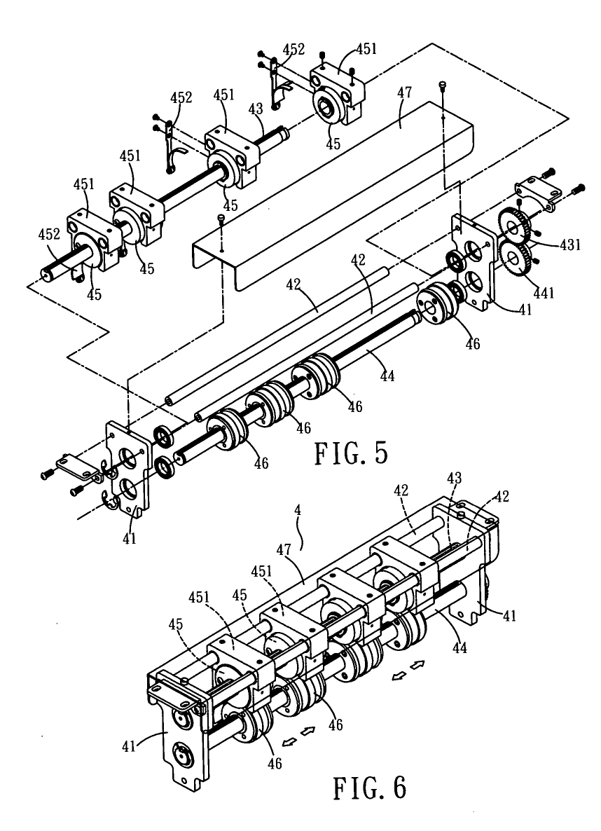

Referring to FIG. 5, the longitudinal cutting unit 4 comprises two fixed side plates 41, two parallel slide rods 42 connecting the side plates 41, an upper wheel shaft 43 and a lower wheel shaft 44 mounted between the side plates 41. One end of the upper wheel shaft 43 and the same end of the lower wheel shaft 44 are respectively provided with an upper gear wheel 431 and a lower gear wheel 441, which gear wheels 431, 441 are engaged. The upper wheel shaft 43 is provided with a plurality of upper wheel knives 45 and a set of wheel knife mounts 451 for retaining the upper wheel knives 45; each of the wheel knife mounts 451 is slidably connected to the slide rods 42 and equipped with a guide member 452. The lower wheel shaft 44 is provided with a plurality of lower wheel knives 46. The various parts of the longitudinal cutting unit 4 are shielded by a cover 47, as shown in FIG. 6.

Moreover, each of the lower wheel knives 46 is provided with a cut groove for engaging the blade of an associated upper wheel knife 45, forming a wheel knife set. Each of the wheel knife sets can change its location by pulling the corresponding wheel knife mount 451 along the slide rods 42, whereby the width of the cards to be cut from the paper material can be adjusted. Further, the upper wheel knives 45 are driven by the upper wheel shaft 43, and the lower wheel knives 46 are driven by the lower wheel shaft 44. Coupled by the upper gear wheel 431 and the lower gear wheel 441, the rotations of the upper wheel shaft 43 and the lower wheel shaft 44 are in opposite senses. The lower wheel shaft 44 is coupled to a driving gear wheel (not shown in the figures), and the driving wheel is driven by a motor transmission set 48, as shown in FIG. 2. Going through the transverse cutting unit 3, the paper sheets are equally divided and will be sent through the upper wheel knives 45 and the lower wheel knives 46 to have a secondary cut perpendicular to the first cut, thereby producing the cards of the desirable size. The waste material produced in the cutting process will be dumped into the waste material collector 5 shown in FIG. 1.

Therefore, the automatic card cutter of the present invention has the advantages as follows.

1. The flexible plates 16 pivotally mounted on the side plates 11 are urged by springs 161 installed on the skewed bottom members 111 extended from the side plates 11 so as to lean against the impression wheels 15, thereby producing a flexible room between the impression wheels 15 and the flexible plates 16 for receiving paper sheet stacks of various amounts while maintaining a constant frictional force between the impression wheels 15 and the flexible plates 16. Therefore, the feeding of paper material can be smooth and uninterrupted.

2. The force on the link rods 115 from the spring 114 can be adjusted by changing the positions of retaining blocks 113 from a pair of the grooves 112 on the top sides of the side plates 11 to another pair, thereby varying the pinch force between the flexible plates 16 and the impression wheels 15. Therefore, the pinch force between the flexible plates 16 and the impression wheels 15 can be changed according to either the fatigue in flexibility of the springs 114, 161 or the surface roughness of the paper material.

3. When the size of the fed paper sheets is large, the secondary flexible plate 18 and the secondary impression wheel 15a assist supporting the weight of the paper sheets and prevent a central downward curvature of the paper sheets due to gravity, which would affect the accuracy of the cutting and even the feeding of material.

4. By turning either one of the adjustment knobs, the spacing between the pull blocks 172 mounted on the two-way screw bolt 173 will be changed, so will the side plates 11 linked to the adjustment frame 17. Therefore, a user can adjust the spacing between the side plates 11 to accommodate paper materials of different widths.

5. The wheel knife sets each composed of one of the upper wheel knives 45 and a corresponding one of the lower wheel knives 46 can be slid along the slide rods 171 by pulling the wheel knife mounts 451. Therefore, the replacement of the longitudinal cutting unit 4 due to changing the cutting width is not necessary.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An automatic card cutter, comprising:
a feeding unit comprising two side plates each provided with a drive set on an inner wall thereof having an impression wheel, a motor set for driving said drive sets through a transmission shaft, two flexible plates pivotally mounted on front sides of said side plates and urged by springs secured on respective skewed bottom members on bottom sides of said side plates, and an adjustment frame straddling across said side plates for adjusting the spacing between said side plate; said flexible plates respectively leaning against said impression wheels of said drive sets, whereby a constant friction between said impression wheels and a stack of paper material will be maintained;
a transport unit;
a transverse cutting unit;
a longitudinal cutting unit;
a waste material collector;
a card collector; and
a shell body retaining and covering said various units described above.

2. The automatic card cutter of claim 1 wherein an upper side of each of said side plates is further provided with a series of descending grooves for the engagement of a retaining block; each of said retaining blocks being connected to a link rod through a spring; each of said link rods having a secondary end secured at said pivot of corresponding said flexible plate.

3. The automatic card cutter of claim 1 wherein a central section of said transmission shaft is further provided with a secondary impression wheel, and wherein a secondary flexible plate is installed between said flexible plates of said side plates and pivotally mounted on a skewed plate in an entry opening of said shell body; said pivotally mounted end of said secondary flexible plate being urged by a spring installed on said skewed plate; a free end of said secondary flexible plate leaning against said secondary impression wheel.

4. The automatic card cutter of claim 1 wherein said adjustment frame further comprises a pair of parallel slide rods, a pair of pull blocks slidably mounted across said slide rods, a two-way screw bolt extended parallel to said slide rods and going through said pull blocks, at least one adjustment knob installed on one end of said two-way screw bolt, and two fixed blocks respectively connecting two ends of said slide rods and said two-way screw bolt.

5. The automatic card cutter of claim 1 wherein said longitudinal cutting unit further comprises two fixed side plates, two parallel slide rods connecting said side plates, an upper wheel shaft provided with an upper gear wheel at one end mounted between said side plates, a lower wheel shaft provided with a lower gear wheel at said end of said upper gear wheel mounted between said side plates, a plurality of upper wheel knives mounted along said upper wheel shaft, a corresponding set of wheel knife mounts for retaining said upper wheel knives each having a guide member, a plurality of lower wheel knives mounted along said lower wheel shaft, and an upper cover.
